(19) United States
(12) Patent Application Publication
(10) Pub. No.: US 2006/0208023 A1
(43) Pub. Date: Sep. 21, 2006

(54) Adventure racing mountain bicycle map holder

(76) Inventor: Mark Manning, San Francisco, CA (US)

Correspondence Address: Mark MANNING, 2340 Pacific Avenue #103, San Francisco, CA, 94115, US

(21) Appl. No.: 11/082,330

(22) Filed: Mar. 17, 2005

(51) Int. Cl. B62J 7/00; B62J 9/00

(52) U.S. Cl. 224/420; 224/448; 224/452

(57) ABSTRACT

The invention described is a bicycle handlebar mounted map holder constructed from folded aluminum sheet with an external bracket to prevent flex of the map holder when riding over rough terrain. The map holder is intended for use in adventure racing or bicycle orienteering to enable the competitor to read the map while keeping both hands on the handlebars.

### TECHNICAL FIELD OF THE INVENTION

To be used to hold topographical maps during the sport of Adventure Racing or Bicycle Orienteering

### DESCRIPTION

This invention relates to the problem of needing to read a map while bicycling in rough terrain and maintaining both hands on the handlebars. Previous map holders had too much flex and were not strong enough to survive the rigors of mountain biking on rough roads. The plastic versions often shattered due to the conflict of wind resistance and hard landings off large bumps. The other alternative was to hang the map around your neck with string or clip it to the straps of a backpack; these methods require holding the map to read it.

### BACKGROUND OF THE INVENTION

During the sport of adventure racing quick navigational decisions need to be made based on the terrain that is being crossed. Having a map that can easily be read while crossing rough terrain and maintaining both hands on the handlebars is essential. The map needs to be stable and in plain view, but not interrupt or disturb the rider. Having researched various existing patents that describe map holders or map holding devices for bicycles that can be easily view by the rider, I have found that they all suffer from various disadvantages as described in the following examples.

U.S. Pat. Nos. 5,222,690 and 5,458,492. These inventions are not designed to be mounted on a bicycle but are designed to be used on much heavier equipment such as a motorcycle or aircraft steering mechanisms. Their design is very heavy and would add a lot of additional weight to a racing bicycle. This weight is very important when participating in a multi day adventure race.

U.S. Pat. No. 5,199,619. This invention is for a large box like structure that attaches to the handlebars and contains multiple compartments for storing various objects. Part of this box contains a map holder. This map holder is very heavy as part of the box and is unsuitable for adventure racing.

U.S. Pat. No. 5,390,957. This invention is a map holder that attaches to a ski pole so as the ski trails can be followed while skiing. It is a clear plastic pouch with straps that attach it to the ski pole. This map holder could also be used for a bicycle but is not stiff or sturdy enough for adventure racing. The map would flap around over rough terrain.

U.S. Pat. No. 5,579,969. This invention is for a wire loop that can hold a map or document mounted to a bicycle handlebar. This wire loop and clip design would not be suitable for adventure racing as it is too flexible and would not be stable on the rough terrain used during adventure racing.

U.S. Pat. No. 4,828,151. This invention holds the map encased in a clear plastic pouch attached between two goalposts made of wire. This design is not strong enough for adventure racing as it will flap excessively when riding over rough terrain.

U.S. Pat. No. 5,106,001. This invention is for a flat mounted map holder that clamps around the handlebars and stem. This map holder is very stable but also uses heavier clamps that are designed to secure the handlebars and stem in the event of a stem bolt failure. This means that the map holder must be made from sturdy material making it heavy and unsuitable for adventure racing. Its location also means that it is possible for the rider to hit their knees on the map holder when riding out of the saddle.

U.S. Pat. No. 6,763,625. This invention is a clear plastic container that can be rolled around a bar or shoulder strap. The plastic container can contain a map that can be read through the clear plastic. This type of container gives a very limited view of the map and has to continually be turned to see the whole picture. It can not be mounted to the bike in a way that allows easy reading while riding.

U.S. Pat. No. 5,044,588. This invention is for a plastic container that houses a map that can be hung from the crossbar or any other tube on a bicycle. This map holder hangs from the bar and must be held up to be read. This kind of map holder is not suitable for adventure racing as it cannot be read while riding. The map is hung out of the way of the rider but also has the potential to swing into the legs of the rider during hard cornering or while riding rough roads.

European patent publication no. 0 596 388 and German patent nos. DE 4313259 and DE 3902824. Patent numbers 0 596 388 and German patent DE 4313259 are for the same device that is used to unroll instructions. This would not be suitable for the type of maps used in adventure racing. German patent DE 3902824 is a plastic container that is mounted on a rotating base that is secured to the handlebars in a horizontal plane. With the additional components required this map holder would be much heavier than the invention described below.

### SUMMARY OF THE INVENTION

The invention is a bicycle handlebar mounted map holder constructed from folded aluminum sheet. This map holder is lightweight and designed to fit almost any mountain bike. It is built strong enough to withstand the rigors of any adventure race or bicycle orienteering event. The map holder is intended for use in adventure racing or bicycle orienteering to enable the competitor to read the map while keeping both hands on the handlebars. The solid construction will not flex or flap on rough roads and will hold most flexible map covers or just the map itself.

### BRIEF DESCRIPTION OF THE FIGURES

FIG. 1 depicts a map holder assembled view showing front, side and top.

FIG. 2 shows a diagram of the flat sheets of aluminum before folding. This diagram is used to mark up the aluminum sheet to cut the shape of the map holder components.

FIG. 3 shows a partially folded main piece of the map holder. The first main fold has taken place and the second and third folds are marked.

FIGS. 4, 5 & 6 show the folding and fixing of the external brace from the single cut piece of aluminum.

FIG. 7 shows the external brace fully assembled view showing front, side and top of the brace.

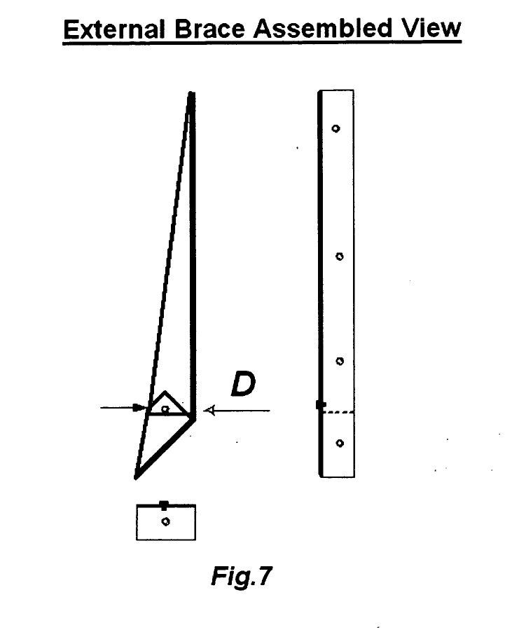

FIG. 8 shows a diagram modifying the mounting bracket.

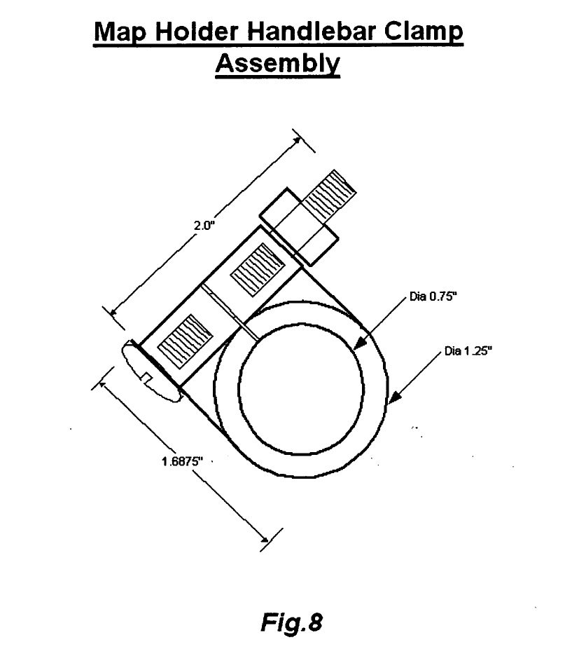

FIG. 9 shows a sketch of the map holder mounted to a bicycle handlebar.

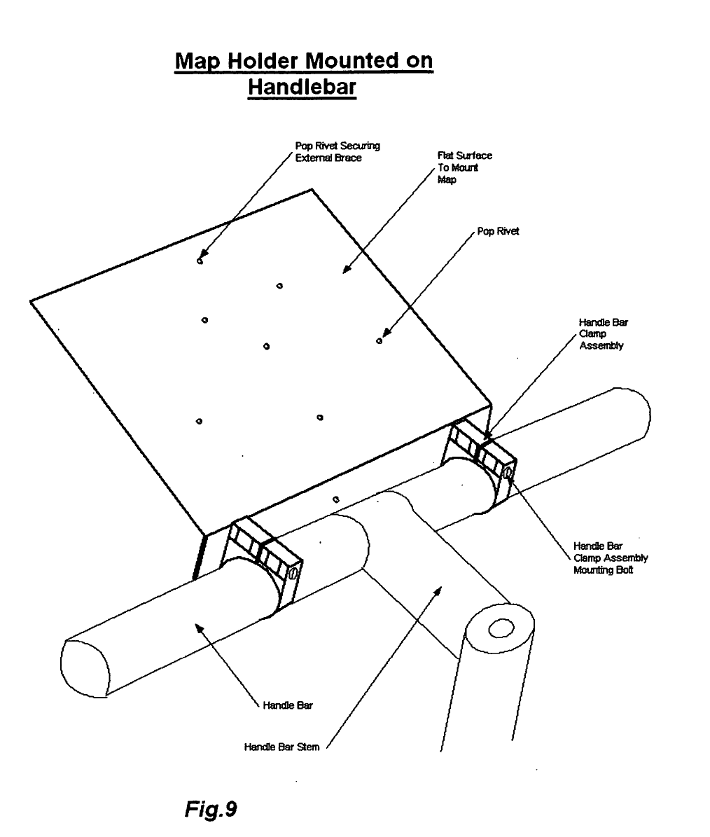

### DETAILED DESCRIPTION OF THE INVENTION

The invention is a bicycle handlebar mounted map holder constructed from folded aluminum sheet. This map holder is lightweight and designed to fit almost any mountain bike. It is built strong enough to withstand the rigors of any adventure race or bicycle orienteering event. The map holder is intended for use in adventure racing or bicycle orienteering to enable the competitor to read the map while keeping both hands on the handlebars. The solid construction will not flex or flap on rough roads and will hold most flexible map covers or just the map itself.

The map itself is attached to the map holder with straps or Velcro type fastenings. If a clear plastic map cover is used then that can also be placed on the map holder in the same way.

The map holder is constructed from 2 pieces of 0.025 aluminum sheet. The first is a flat sheet that is folded and cut to from a flat platform with an angled piece 1.25″ long that allows the mounting brackets to attach the map holder to the bicycle handlebars. The second piece of aluminum is cut and folded in such a way as to create a brace that will prevent the flat portion of the map holder from flexing while riding. The brace is riveted to the underside of the flat portion of the map holder creating a stiff platform that is mounted to the bicycle handlebars. The map holder is mounted to the handlebars with 2 plastic brackets that clamp around the bars. The clamps are held closed by two 2″×0.25″ bolts and nylock nuts.

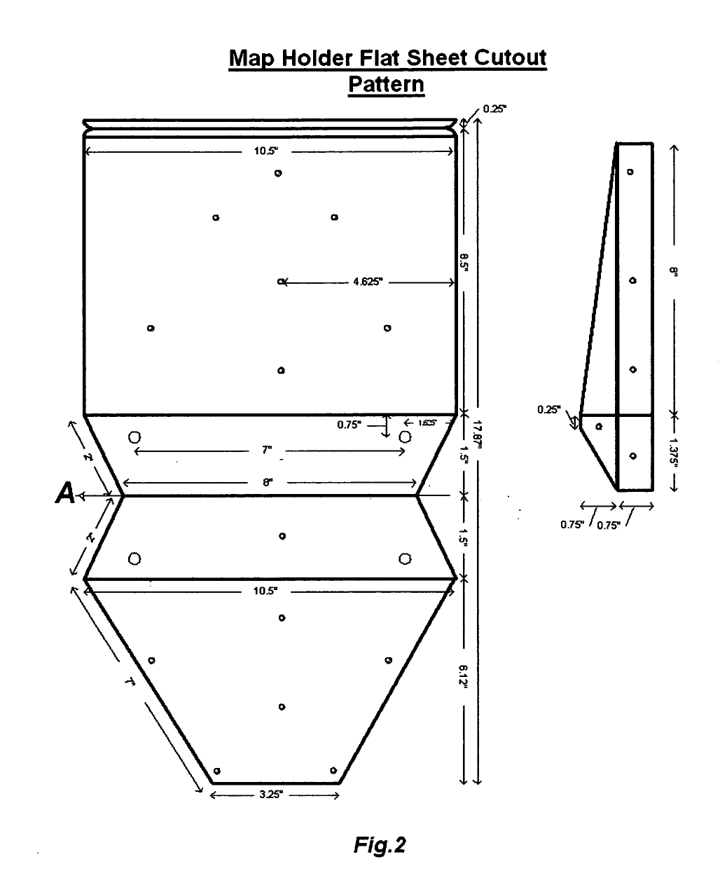

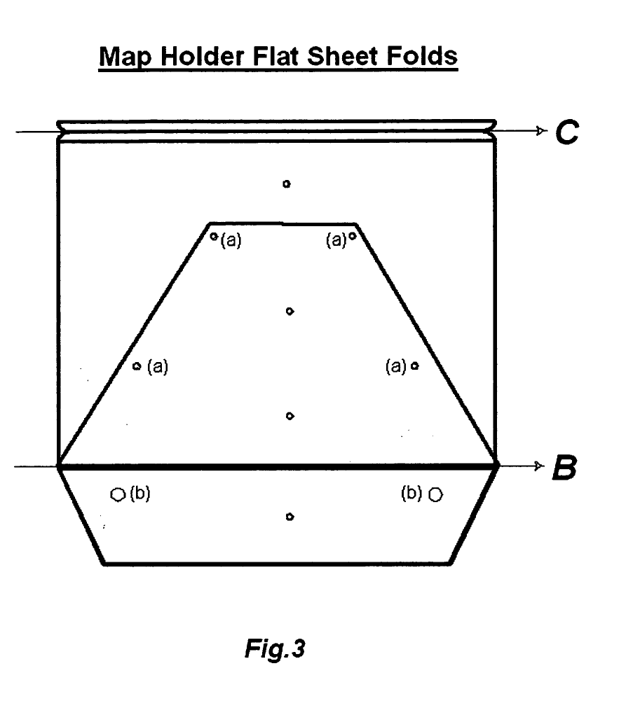

The flat piece of 0.025″ aluminum is first marked with the shape shown in the diagram labeled FIG. 2. Once the shape is cut out it is folded 180 deg along the line marked A on FIG. 2. Once this fold has been made and the sheet is flat again, the newly formed piece is bent again in the same direction to an angle of 135 deg along line B as shown in FIG. 3. Once this bend is firm the flat folded sheet it is secured using pop rivets in the holes marked (a).

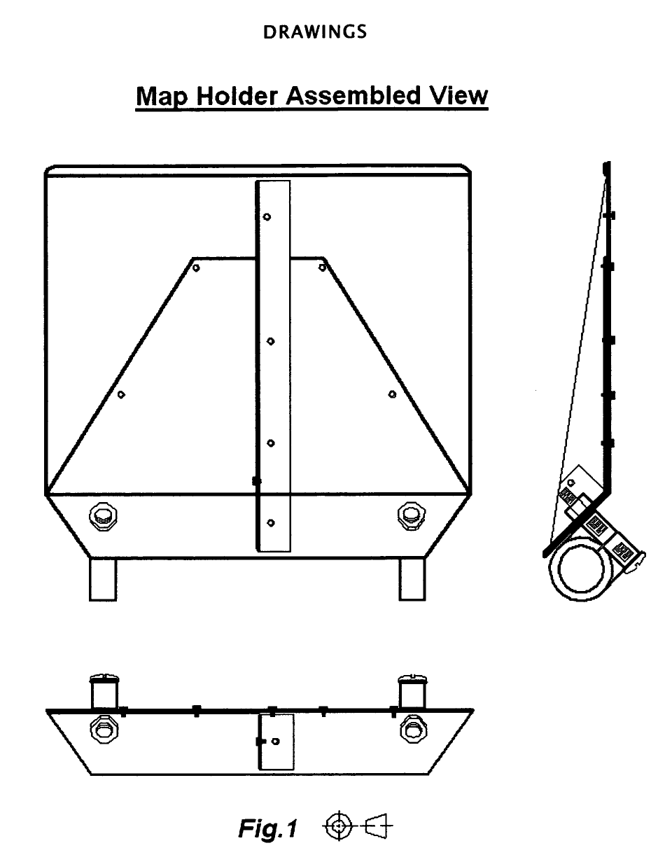

The next step is to stiffen the top edge of the map holder by bending 0.25″ of the top edge over along line C as shown in FIG. 3, and flattening it to form a smooth edge at the top of the map holder. This will create the shape shown in FIG. 1.

Two 0.25″ holes should be drilled at the locations marked (b) on FIG. 3. These holes are for the mounting bracket bolts that are used to attach the mounting brackets to the map holder.

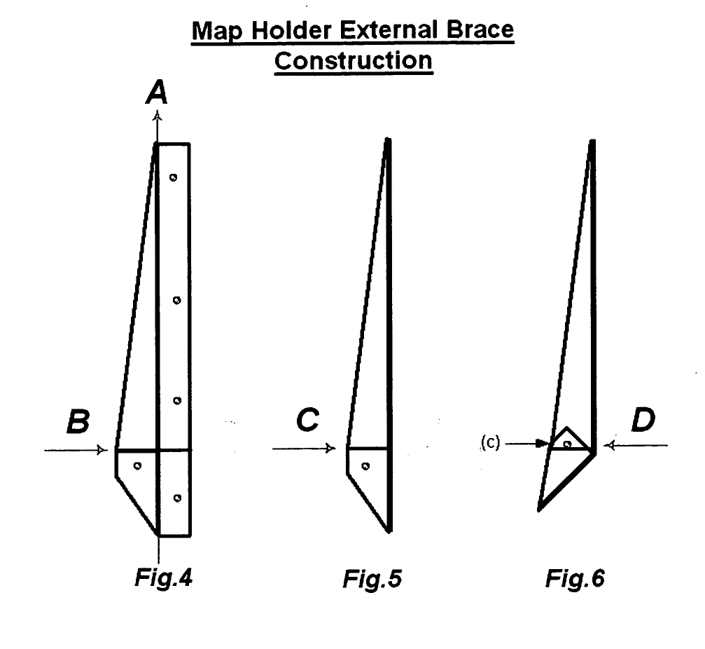

The external stiffener bar is constructed from a flat piece of aluminum cut to the shape shown in FIG. 4. This piece is then folded at 90 deg along the line A. This is then cut at the line marked B to the fold at line A. This piece is then folded at point D to an angle of 225 deg to overlap the piece at the cut forming the shape shown in FIG. 5. The bend angle should match the shape of the underside of map holder surface. Once the angle has been confirmed a hole should be drilled at point (c) and the bend angle should be fixed with a pop rivet.

The external brace is now ready to attach to the flat section of the map holder. The external brace should be placed centrally against the flat piece of the map holder and attached using pop rivets as shown in FIG. 1.

The complete map holder is attached to the handlebars of the bike using 2 plastic plumbing type brackets that are designed to hold ¾″ heating pipes in place. These brackets are modified to suit the task of holding the aluminum map holder to the handlebars.

For the map holder the nail is removed and the nail hole is enlarged using a ¼″ drill bit. Once the hole is enlarged the plastic bracket is placed around the handle bar of the bicycle and a 2″×¼ bolt is passed through the hole in the bracket from the rider side of the handle bar. The front of the map holder is then placed against the plastic bracket with the bolts passing through the ¼″ holes that were drilled in the flat aluminum sheet. A ¼″ nylock nut is then used to hold the map holder in place as shown in FIG. 1. The second bracket is attached in the same way ensuring that no cables or wires from the bike are caught in the brackets. Before the bolts are finally tightened the map holder is adjusted to the correct angle for reading. The bolts are then tightened to firmly hold the map holder in place.

This map holder is superior to previous clear plastic versions because of the following benefits:

Aluminum is stronger and not susceptible to shattering under extreme circumstances.

If the map holder is bent during a crash it can be straightened by hand.

The aluminum material is lighter when using 0.025″ sheet.

The map holder uses an external stiffener to reduce flex.

The map holder has multiple methods for attaching the map.

The map can be easily removed and reattached during use.

The map holder is constructed from readily available materials.

The map holder uses plastic mounting brackets available at the hardware store.

This map holder is very cheap and simple to make.

Using a map holder is safer than conventional methods of map reading.

What is claimed is:

1. A method for the design of a bicycle map holder that is constructed from folded and riveted sheet aluminum comprising of a flat section with a partial bend at one end and an external bracket to reduce flex

2. A method according to claim 1 where plastic plumbing type mounting brackets are used to hold the map holder to the front of the bicycle handlebars, after the hole has been enlarged and the nail replaced with a bolt.

3. A method according to claim 1 for the use of an external brace design to reduce the flex of the map holder when mounted to the handlebars.
